(19) United States
(12) Patent Application Publication
(10) Pub. No.: US 2005/0091907 A1
(43) Pub. Date: May 5, 2005

(54) Fishing accessory ring

(76) Inventor: Tom Testa, Windsor, CT (US)

Correspondence Address: CANTOR COLBURN, LLP, 55 GRIFFIN ROAD SOUTH, BLOOMFIELD, CT, 06002, US

(21) Appl. No.: 10/806,322

(22) Filed: Mar. 22, 2004

Related U.S. Application Data
(60) Provisional application No. 60/457,083, filed on Mar. 21, 2003.

(51) Int. Cl. A01K 97/06

(52) U.S. Cl. 43/25.2

(57) ABSTRACT

A fishing accessory ring is provided, which advantageously provides at least one accessory ring near the reel seat or rod shaft. In one exemplary embodiment, the accessory ring comprises a first aperture configured to engage a circumferential portion of a support member, e.g., a rod or rod and reel combination, and at least a second aperture configured to extend away from such first aperture. In another exemplary embodiment, such accessory ring comprises an additional (third) aperture configured to extend away from such first aperture. In another embodiment, such accessory ring is configured with a first aperture configured to engage a support member, and a plurality of additional apertures positioned at least partially around the circumference of the first aperture. In another exemplary embodiment, said first aperture comprises a plurality of pieces, comprising at least a first piece removably coupled to a second piece, and wherein said assembled form of said plurality of pieces is configured to engage a circumferential portion of a rod or rod and reel combination. In another exemplary embodiment, said first aperture is threaded, wherein said threaded portion of said first aperture is configured to thread onto a threaded portion of a rod or rod and reel combination. In another exemplary embodiment, such first aperture is configured to engage a reel seat as well as a tab of a reel hood (effectively acting as a reel hood and accessory ring, at the same time).

### CROSS REFERENCE TO RELATED APPLICATIONS

The present application claims priority to co-pending U.S. patent application Ser. No. 60/457,083, filed Mar. 21, 2003, the entire contents of which are specifically incorporated herein by reference.

### BACKGROUND

Fishing rods generally comprise a plurality of separate elements, including a rod element, a reel element, which is mounted to the rod, and a fishing line/tackle element. The rod element may include a rod blank, rod grips fitted to the fishing rod, a reel seat, also fitted to the fishing rod and including forward and rear reel seat hoods, guides/runners affixed to the blank forward of the reel seat

A typical fishing reel includes forward and rear tabs, which are received in a mounting position, underneath forward and rear reel seat hoods, which may include an aperture therein configured generally to receive and hold the reel tabs. Oftentimes, one reel seat hood, e.g., the rear hood, is fixed, and one reel seat hood, e.g., the forward hood, is slidable over the rear seat to accommodate a plurality of reel sizes and to slide into a reel mounted position. A securing member, e.g., a threaded ring on a threaded portion of the reel seat, is then tightened over the forward hood to secure the forward hood against the reel tabs, and thus, to secure the reel on the rod.

Fishing line depends from the reel and is fed through guides/runners from the reel through the tip of rod, where the line is attached to the tackle, which may include floats, weights, hooks, etc. During use, such tackle is either dropped or cast into the water and is used to secure fish. During storage, such tackle is either drawn as far towards the tip as possible or is drawn up such that one or more hooks snugly engages one of the guides/runners. However, such storage is not typically optimal, particularly where the hook(s) are permitted to swing free during storage. Accordingly, there is a need for alternate solutions.

Certain reels may also include harness lugs designed to receive hooks from a harness. However, attaching tackle, harness hooks or safety lines to reel harness lugs oftentimes results in scratching of expensive reels. Also, reel bags do not usually fit when rods are stored with tackle attached to harness lugs. Thus, reel bags are either not used, or tackle is disconnected prior to using reel bags. While it known to hook harnesses to reel harness lugs, there has heretofore not been a way to attach tackle, harnesses or safety lines to fishing rods.

### SUMMARY

The above described disadvantages and problems are alleviated by the present fishing accessory ring, which in one embodiment advantageously provides at least one accessory ring on a portion of the reel seat or rod shaft. In one exemplary embodiment, the accessory ring comprises a first aperture configured to engage a circumferential portion of a rod or rod and reel combination and at least a second aperture or portion of an aperture configured to extend away from the first aperture. In another exemplary embodiment, such accessory ring comprises an additional (third) aperture configured to extend away from the first aperture.

In another embodiment, the accessory ring comprises a first aperture configured to engage a support member and a plurality of apertures positioned adjacent the first aperture, the plurality of apertures sized and configured to receive at least one of an article of fishing tackle, such as a fishing hook, a fishing harness connector and a fishing safety line. The first aperture may be configured as a fishing rod accessory ring, wherein the first aperture is configured to engage a portion of a fishing rod or more generally as a fishing accessory ring, wherein the first aperture is configured to engage some other support member, for example a chair post.

In another exemplary embodiment, the first aperture is at least partially defined by a plurality of pieces, comprising at least a first piece removably coupled to or initially decoupled from a second piece, and wherein said assembled form of said plurality of pieces is configured to engage a circumferential portion of a rod or rod and reel combination. In another exemplary embodiment, said first aperture is threaded, wherein said threaded portion of said first aperture is configured to thread onto a threaded portion of a rod or rod and reel combination.

In another exemplary embodiment, such first aperture is configured to engage a reel seat as well as a tab of a reel hood (effectively acting as a reel hood and accessory rod ring, at the same time).

The above description and other features and advantages of the present fishing accessory ring will be appreciated and understood by those skilled in the art from the following detailed description, drawings, and appended claims.

### BRIEF DESCRIPTION OF DRAWINGS

Referring now to the drawings wherein like elements are numbered alike in the several FIGS:

FIG. 1 is a perspective view of a rod and reel combination utilizing an exemplary embodiment of an accessory ring;

FIG. 2 is a top elevation view of an exemplary embodiment of an accessory ring;

FIG. 3 is a plan view of an exemplary embodiment of a multiple piece accessory ring; and

FIG. 4 is a perspective view of an exemplary accessory ring including a first aperture configured to engage a chair post and a plurality of additional apertures configured to engage safety lines.

### DETAILED DESCRIPTION

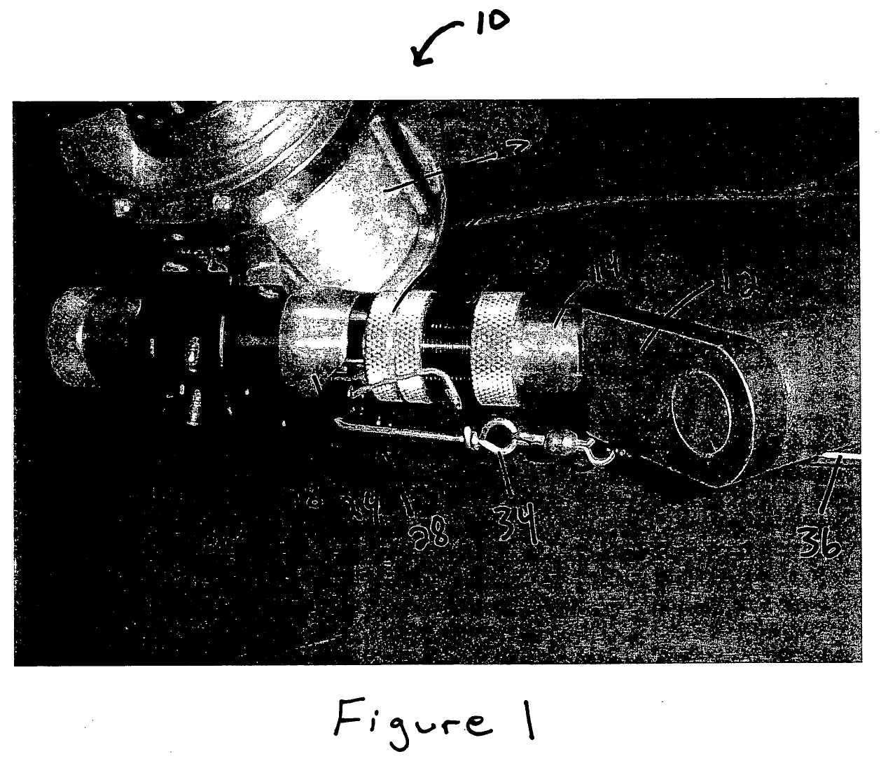

Referring now to FIG. 1, an exemplary rod and reel combination including an exemplary embodiment of the presently described fishing accessory ring is illustrated. The illustrated exemplary rod and reel combination, shown generally at 10, includes a forward handle/grip portion 12, a forward shaft portion 14, and a reel seat portion, shown generally at 16 and including a reel mounting portion 18, a forward threaded portion 20, rear and forward reel seat hoods 22, 24, and threaded securing member 26. An exemplary fishing accessory ring, shown generally at 28, is illustrated in one exemplary installed location on the reel seat portion 16, between the forward reel seat hood 24 and the threaded securing member 26. Exemplary reel 30 and reel mounting accessory 32 are illustrated in an installed position on the reel seat 16. A rearward shaft/grip portion 34 extends rearwardly from the reel seat portion 16. Tackle 34, attached to line 36, is illustrated in an engaged position with an aperture of the exemplary fishing accessory ring 28.

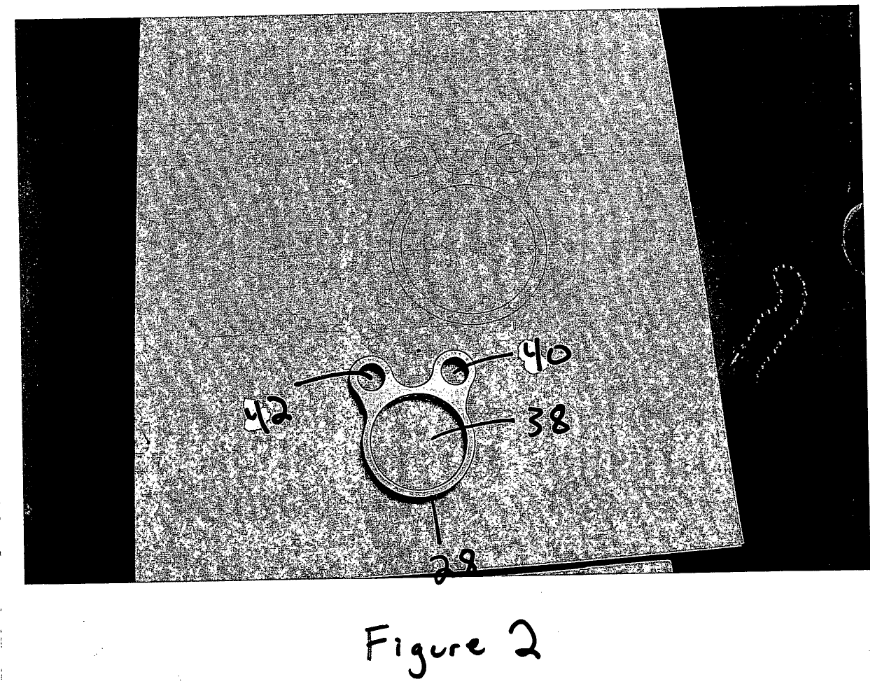

Referring now to FIG. 2, an exemplary fishing accessory ring 28 is illustrated in a top elevation view. The illustrated exemplary ring 28 comprises a one-piece ring, including a first aperture 38, generally configured to engage a circumferential portion of a rod or rod and reel combination. The illustrated exemplary ring also comprises a second aperture 40, displaced from the first aperture 38. The illustrated exemplary ring also comprises a third aperture 42, displaced from both the first and second apertures 38, 40.

The exemplary ring 28 may be any material. It may also be constructed by any suitable manner, e.g., by machining, casting, molding, etc. In one embodiment, such exemplary ring is an aluminum material. The exemplary ring may also have variable dimensions, the only requirement being that the first aperture 38 be generally configured to engage a circumferential portion of a rod or rod and reel combination. Accordingly, thickness of the overall piece (from the outer portion of the first aperture to the outer portion of the accessory ring) may vary, length of the ring (from the top portion to the bottom portion) may vary, and the sizes of the second and/or third (or additional) apertures may vary.

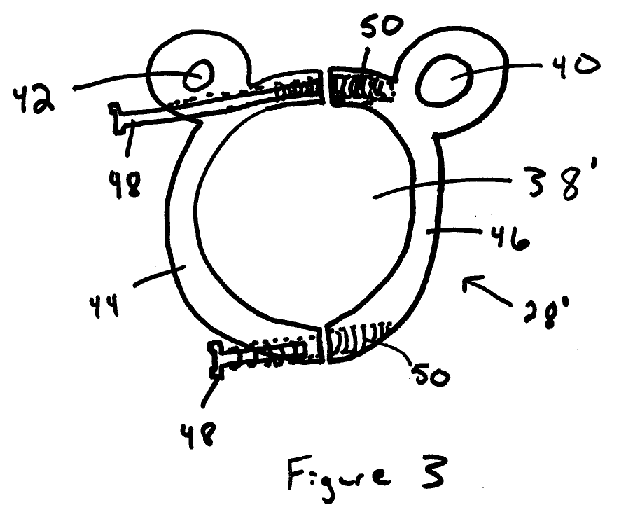

Referring now to FIG. 3, an exemplary multiple piece accessory ring 28′ is illustrated in plan view. Said multiple piece accessory ring 28′ generally comprises a first aperture 38′ , defined by a first ring piece 44 and a second ring piece 46 when the first and second ring pieces 44, 46 are at least partially coupled to one another. In one exemplary embodiment (as illustrated), such ring pieces are removably coupled, including at least one screw 48 positionable within a threaded portion 50 of the accessory ring 28′. While screws 48 and threaded portions 50 are illustrated, the present disclosure contemplates any other type of coupling, removable or not, e.g., adhesives, latches, cinches, and equivalents.

Additionally, the present disclosure contemplates non-rigid, or partially rigid, accessory ring configurations, wherein the first aperture 38 may be distended to mount on a rod or rod and reel combination portion or other support structures for subsequent securing around such portion (e.g., by cinching). Additionally, the presently described accessory ring may share the additional functions of a rod or rod and reel combination portions, e.g., the first aperture 38 of the accessory ring may additionally be configured to engage a reel tab (thus, additionally functioning as a reel seat hood), or may be threaded (for use or not as a securing member 26.

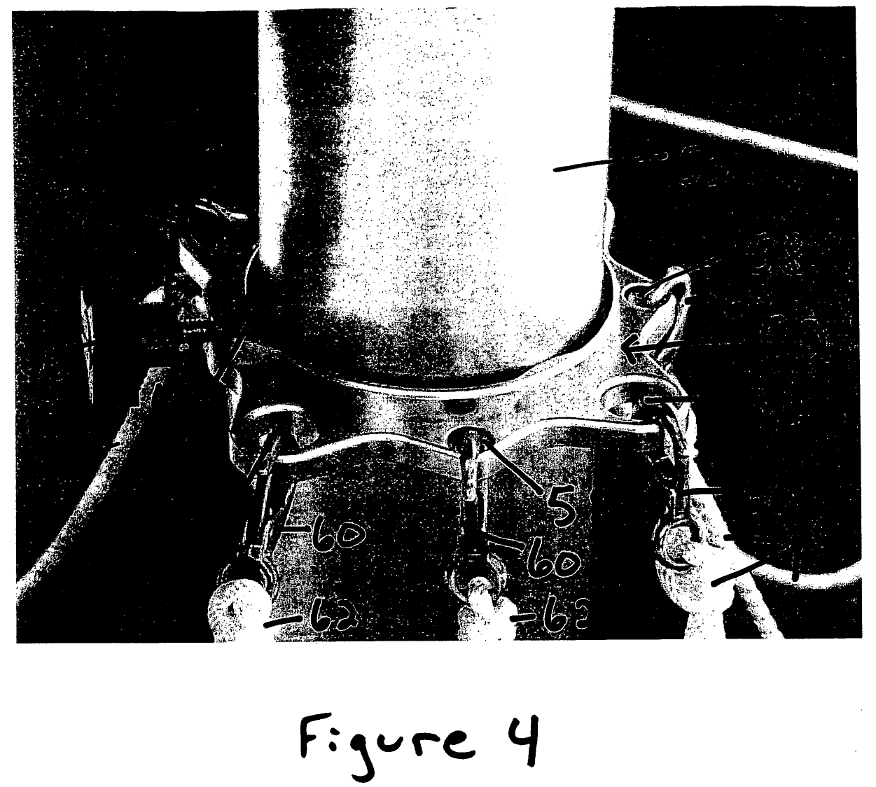

Referring now to FIG. 4, an exemplary accessory ring 52 is illustrated in a mounted position comprising a first aperture 54, which encircles a support structure 55(e.g., a chair post for a fishing boat), a first plurality of apertures 56 having a first diameter, and a second plurality of apertures 58 having a second diameter. The first and second plurality of apertures 56, 58 are provided disposed at least partially around the circumference of the first aperture 54. In the illustrated embodiment, a plurality of clips 60 are attached to the first and second plurality of apertures 56, 58 on one end and to safety lines 62 on a second end.

Additionally, the first aperture 54 in the illustrated exemplary embodiment has an inner circumference larger than that of the outer circumference of the support structure 55. Accordingly, a biasing member 64, illustrated in the exemplary embodiment as a threaded screw 64 attached to a handle 66, is configured to apply a force from the accessory ring 52 onto the support structure 55. Such biasing member 66 permits selective securing of the accessory ring 52 to the support structure 55.

While exemplary embodiments have been shown and described, various modifications and substitutions may be made thereto without departing from the spirit and scope of the invention. Accordingly, it is to be understood that the present invention has been described by way of illustration and not limitation.

1. A fishing rod accessory ring, comprising:
a first aperture provided in a first material, the first aperture configured to engage a portion of a rod or rod and reel combination; and
a second aperture provided in a second material, the second aperture extending away from the first aperture, the second aperture configured to engage one or more of an article of fishing tackle, a harness line or hook and a safety line or hook.

2. The fishing rod accessory ring in accordance with claim 1, further comprising a third aperture provided in a third material, the third aperture extending away from the first aperture, the third aperture configured to engage one or more of an article of fishing tackle, a harness line or hook and a safety line or hook.

3. The fishing rod accessory ring in accordance with claim 1, wherein the first and second material form a contiguous article defining the first and second apertures.

4. The fishing rod accessory ring in accordance with claim 1, wherein the first and second apertures are completely distinct apertures such that the second aperture is spaced from the first aperture by a portion of one of the first and second materials.

5. The fishing rod accessory ring in accordance with claim 4, wherein the first and second apertures are spaced from one another by more than one millimeter.

6. The fishing rod accessory ring in accordance with claim 2, wherein the first, second and third materials form a contiguous article defining the first, second and third apertures.

7. The fishing rod accessory ring in accordance with claim 2, wherein the first, second and third apertures are completely distinct apertures such that the second aperture is spaced from the first aperture by a portion of one or both of the first and second materials and such that the third aperture is spaced from the first aperture by a portion of one or both of the first and third materials.

8. The fishing rod accessory ring in accordance with claim 2, wherein the second and third apertures have substantially the same diameters.

9. The fishing rod accessory ring in accordance with claim 7, wherein the first and second apertures and the first and third apertures are spaced from one another by more than one millimeter.

10. The fishing rod accessory ring in accordance with claim 2, wherein the second and third apertures are substantially circular in cross section.

11. The fishing rod accessory ring in accordance with claims 1 and 2, wherein the first material comprises at least two portions configured to be coupled into an assembled state.

12. The fishing rod accessory ring in accordance with claim 11, wherein the at least two portions are configured to be removably coupled.

13. The fishing rod accessory ring in accordance with claim 12, wherein the at least two portions are removably coupled with at least one threaded member.

14. The fishing rod accessory ring in accordance with claims 1 and 2, wherein at least a portion of the first material is threaded such that the first aperture may be threaded onto a corresponding threaded portion of a rod or rod and reel combination.

15. The fishing rod accessory ring in accordance with claims 1 and 2, wherein the first aperture is configured to engage mounting portion of a reel such that the first aperture constrains a portion of the reel against the rod.

16. The fishing rod accessory ring in accordance with claim 2, wherein the second and third apertures are provided around at least a portion of the circumference of the first aperture.

17. A fishing accessory ring, comprising:
a first aperture provided in a first material, the first aperture configured to engage a support structure; and
a second aperture provided in a second material, the second aperture extending away from the first aperture, the second aperture configured to engage one or more of an article of fishing tackle, a harness line or hook and a safety line or hook.

18. The fishing accessory ring in accordance with claim 17, wherein the support structure is a post configured to mount on a portion of a boat.

19. The fishing accessory ring in accordance with claim 17, wherein the first aperture has a circumference greater than the outer circumference of the support structure, and wherein the accessory ring includes a biasing member configured to selectively secure the accessory ring to the support structure.

20. The fishing accessory ring in accordance with claim 19, wherein the biasing member comprises a threaded member extending through at least a portion of the first material through the circumference of the first aperture.

21. The fishing accessory ring in accordance with claim 17, wherein a plurality of apertures are provided around the first aperture.

22. The fishing accessory ring in accordance with claim 21, wherein at least two of the plurality of apertures have differing diameters.

23. A fishing rod, comprising:
a shaft portion; and
a first material at least partially surrounding the shaft portion, the first material connected to at least a second material, the at least second material defining an aperture therethrough configured to engage one or more of an article of fishing tackle, a harness line or hook and a safety line or hook.

24. The fishing rod in accordance with claim 23, wherein the first and second material are contiguous.

25. The fishing rod in accordance with claim 23, wherein a plurality of apertures are provided in material provided at least partially around the circumference of the shaft portion of the fishing rod.
